(19) United States
(12) Patent Application Publication
(10) Pub. No.: US 2007/0075931 A1
(43) Pub. Date: Apr. 5, 2007

(54) Plasma display device

(75) Inventors: Makoto Onozawa, Yokohama (JP); Yasunobu Hashimoto, Kawasaki (JP); Tomokatsu Kishi, Yamato (JP); Masayuki Shibata, Yokohama (JP)

Correspondence Address: MCDERMOTT WILL & EMERY LLP, 600 13TH STREET, N.W., WASHINGTON, DC, 20005-3096, US

(73) Assignee: FUJITSU HITACHI PLASMA DISPLAY LIMITED

(21) Appl. No.: 11/525,949

(22) Filed: Sep. 25, 2006

(30) Foreign Application Priority Data
Sep. 30, 2005 (JP) 2005-287265

(51) Int. Cl. G09G 3/28

(52) U.S. Cl. 345/67

(57) ABSTRACT

A plasma display device is provided which has a first substrate and a second substrate; a first electrode and a second electrode formed on the first substrate to perform sustain discharge on the first substrate; a third electrode formed on the second substrate to perform address discharge between the second electrode and the third electrode; a dielectric layer formed of a silicon oxide film in a manner to cover the first and second electrodes on the first substrate; and a discharge gas existing between the first and second substrates and having a Xe concentration within 10%±2.5%. The dielectric layer has a thickness within 10 μm±2.5 μm. The first to third electrodes constitute one pixel, and display of 1920×1080 pixels is possible.

### CROSS-REFERENCE TO RELATED APPLICATIONS

This application is based upon and claims the benefit of priority from the prior Japanese Patent Application No. 2005-287265, filed on Sep. 30, 2005, the entire contents of which are incorporated herein by reference.

### BACKGROUND OF THE INVENTION

1. Field of the Invention

The present invention relates to a plasma display device.

2. Description of the Related Art

The plasma display device, which is a large flat display and whose market is expanding as a home flat television, is required to have the power consumption, display quality, and cost at the same levels as those in a CRT.

In the following Patent Document 1, a manufacturing method is described which, in manufacture of a gas discharge display device having a dielectric layer covering electrodes X and Y arranged on a substrate and spreading over the entire display region, forms a layer as the dielectric layer isotropically covering the surface of a base film of a formed film by the plasma chemical vapor deposition method on the surface of a substrate structure after the stage of arrangement of the electrodes X and Y.

Besides, the following Patent Document 2 describes a plasma display panel in which the composition ratio of a discharge gas is 2% to 20% Xe, 15% to 50% He, the He composition ratio is greater than the Xe composition ratio, the total pressure of the discharge gas is 400 Torr to 550 Torr, and the width of the voltage pulse applied to the address electrode is 2 μs or less.

(Patent Document 1)

Japanese Patent Application Laid-open No. 2000-21304

(Patent Document 2)

Japanese Patent Application Laid-open No. 2003-346660

Further, an HDTV (High Definition Television) is being developed. The HDTV has a large number of pixels, and therefore has a problem of decreased light-emitting area per pixel and reduced brightness.

### SUMMARY OF THE INVENTION

An object of the present invention is to provide a plasma display device with high brightness.

A plasma display device of the present invention is characterized by including a first substrate and a second substrate; a first electrode and a second electrode formed on the first substrate to perform sustain discharge on the first substrate; a third electrode formed on the second substrate to perform address discharge between the second electrode and the third electrode; a dielectric layer formed of a silicon oxide film in a manner to cover the first and second electrodes on the first substrate; and a discharge gas existing between the first and second substrates and having a Xe concentration within 10%±2.5%, wherein the dielectric layer has a thickness within 10 μm±2.5 μm, and wherein the first to third electrodes constitute one pixel, and display of 1920×1080 pixels is possible.

Further, a plasma display device of the present invention is characterized by including a first substrate and a second substrate; a first electrode and a second electrode formed on the first substrate to perform sustain discharge on the first substrate; a third electrode formed on the second substrate to perform address discharge between the second electrode and the third electrode; and a dielectric layer formed of a silicon oxide film in a manner to cover the first and second electrodes on the first substrate, and having a thickness within 10 μm±2.5 μm.

### BRIEF DESCRIPTION OF THE DRAWINGS

FIG. 1 is a diagram showing a configuration example of a plasma display device according to a first embodiment of the present invention;

FIG. 2 is an exploded perspective view showing a configuration example of a plasma display panel according to the first embodiment;

FIG. 3 is a circuit diagram showing a configuration example of each sustain circuit in an X-electrode drive circuit and a Y-electrode drive circuit;

FIG. 4 is a diagram showing an example of a sustain discharge pulse to an X electrode generated by the sustain circuit in FIG. 3;

FIG. 5 is a diagram showing a configuration example of one frame of an image according to the first embodiment;

FIG. 6 is a graph showing the relationship between the Xe concentration in a discharge gas and a sustain discharge voltage;

FIG. 7 is a graph showing the relationship between the thickness of a dielectric layer and the sustain discharge voltage;

FIG. 8 is a graph showing the relationship between the thickness of the dielectric layer and a gas discharge current;

FIG. 9 is a circuit diagram showing a configuration example of a sustain circuit for generating the sustain discharge pulse in FIG. 10;

FIG. 10 is a diagram showing a configuration example of one frame of an image according to a second embodiment of the present invention;

FIGS. 11A to 11C are views showing a configuration example of ribs, X electrodes, Y electrodes and address electrodes according to a third embodiment of the present invention; and

FIG. 12 is a plan view showing a configuration example of bus electrodes, transparent electrodes and ribs.

### DETAILED DESCRIPTION OF THE PREFERRED EMBODIMENTS

(First Embodiment)

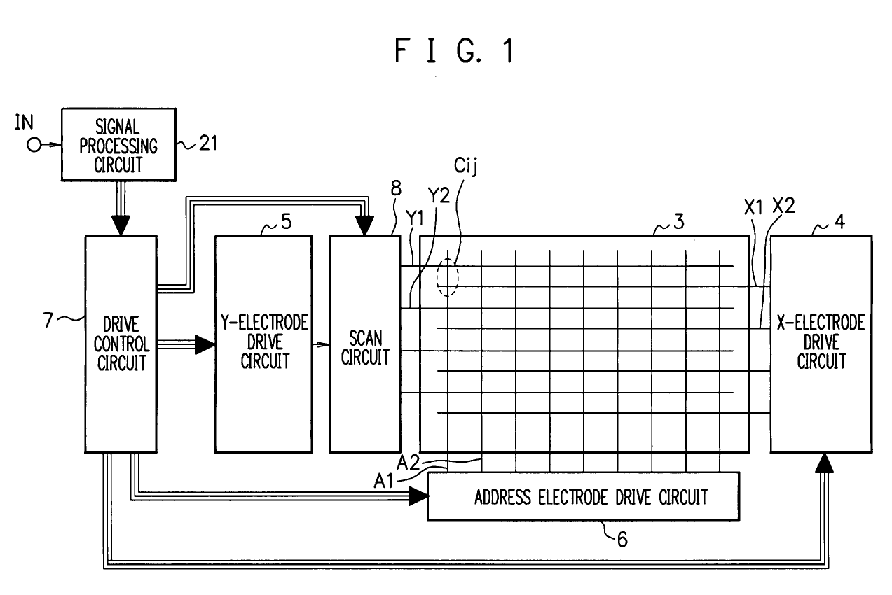

FIG. 1 is a diagram showing a configuration example of a plasma display device according to a first embodiment of the present invention. A signal processing circuit 21 processes a signal inputted from an input terminal IN and outputs the processed signal to a drive control circuit 7. The drive control circuit 7 controls an X-electrode drive circuit 4, a Y-electrode drive circuit 5, a scan circuit 8, and an address electrode drive circuit 6. The X-electrode drive circuit 4 supplies a predetermined voltage to a plurality of X electrodes X1, X2, and so on. Hereinafter, each of the X electrodes Xl, X2, and so on or their generic name is referred to as an X electrode Xi, i representing a suffix. The Y-electrode drive circuit 5 supplies a predetermined voltage to a plurality of Y electrodes Y1, Y2, and so on via the scan circuit 8. Hereinafter, each of the Y electrodes Y1, Y2, and so on or their generic name is referred to as a Y electrode Yi, i representing a suffix. The address electrode drive circuit 6 supplies a predetermined voltage to a plurality of address electrodes A1, A2, and so on. Hereinafter, each of the address electrodes A1, A2, and so on or their generic name is referred to as an address electrode Aj, j representing a suffix.

Within a plasma display panel 3, the Y electrodes Yi and the X electrodes Xi form rows extending in parallel in the horizontal direction, and the address electrodes Aj form columns extending in the vertical direction. The Y electrodes Yi and the X electrodes Xi are arranged alternately in the vertical direction. The Y electrodes Yi and the address electrodes Aj form a two-dimensional matrix with i rows and j columns. A display cell Cij is formed of an intersection of the Y electrode Yi and the address electrode Aj and the X electrode Xi correspondingly adjacent thereto. This display cell Cij corresponds to a pixel, so that the plasma display panel 3 can display a two-dimensional image. A full-specification HDTV has 1920 (in the horizontal direction)×1080 (in the vertical direction) pixels.

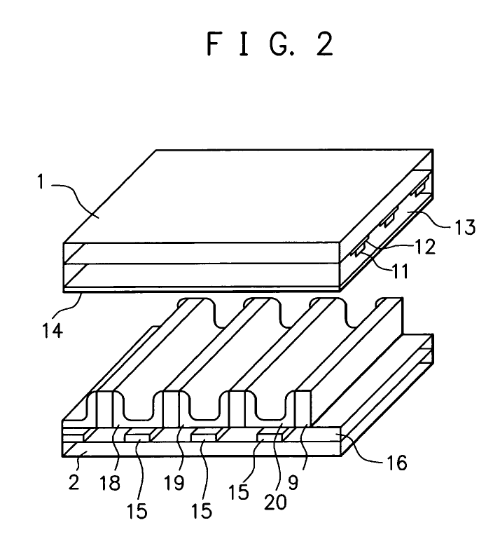

FIG. 2 is an exploded perspective view showing a configuration example of the plasma display panel 3 according to this embodiment. Bus electrodes 11 are formed on transparent electrodes 12. The pairs of the electrodes 11 and 12 correspond to the X electrodes Xi or the Y electrodes Yi in FIG. 1. The X electrodes Xi and the Y electrodes Yi are alternately formed on a front glass substrate 1. On the electrodes 11 and 12, a dielectric layer 13 for insulating them from a discharge space is deposited to cover them. The dielectric layer 13 is a silicon oxide film (SiO₂) formed by the plasma CVD (Chemical Vapor Deposition) method and has a thickness of 10 μm. On the dielectric layer 13, a MgO (magnesium oxide) protective film 14 is further deposited. On the other hand, address electrodes 15, which correspond to the address electrodes Aj in FIG. 1, are formed on a rear glass substrate 2 which is disposed to oppose the front glass substrate 1. On the address electrodes 15, a dielectric layer 16 is deposited. Further, a red phosphor layer 18, a green phosphor layer 19, and a blue phosphor layer 20 are deposited on the dielectric layer 16. On an inner surface of a partition (rib) 9, the phosphor layers 18 to 20 in red, blue and green are applied, arranged in stripes for each color. A discharge between the X electrode Xi and the Y electrode Yi excites the phosphor layers 18 to 20 to emit light in the colors. In the discharge space between the front glass substrate 1 and the rear glass substrate 2, a discharge gas such as a Ne+Xe Penning gas or the like is filled. The discharge gas has a Xe concentration of 10%.

FIG. 5 is a diagram showing a configuration example of one frame fk of an image according to this embodiment. The image is constituted of a plurality of frames fk−1, fk, fk+1 and so on. The one frame fk is formed of, for example, a first sub-frame sf1, a second sub-frame sf2, . . . and an eighth sub-frame sf8. Each of the sub-frames sf1, sf2 and so on or their generic name is referred to as a sub-frame sf. Each sub-frame sf has a weight corresponding to the number of gradation bits.

Each sub-frame sf is composed of a reset period TR, an address period TA, and a sustain discharge period TS. During the reset period TR, the display cell Cij is initialized. To the Y electrode Yi, a positive dull wave (a waveform having a positive inclination) Pr1 and a negative dull wave (a waveform having a negative inclination) Pr2 are applied. An amplitude absolute value V1 of the reset pulse Pr1 applied to the Y electrode Yi to reset the display cell Cij is 180 V to 200 V.

During the address period TA, emission or non-emission of each display cell Cij can be selected by address discharge between the address electrode Aj and the Y electrode Yi. More specifically, a scan pulse Py is applied to the Y electrodes Y1, Y2, Y3, Y4, . . . and so on in sequence, and an address pulse Pa is applied to the address electrode Aj in correspondence with the scan pulse Py, whereby emission or non-emission of a desired display cell Cij can be selected.

An amplitude absolute value V3 of the address pulse Pa applied to the address electrode Aj to cause address discharge between the Y electrode Yi and the address electrode Aj is 60 V to 70 V. An amplitude absolute value V2 of the scan pulse Py applied to the Y electrode Yi in correspondence with the address pulse Pa is 110 V to 130 V.

During the sustain period TS, sustain discharge is performed between the X electrode Xi and the Y electrode Yi of the selected display cell Cij to emit light. The number of light emission times (the duration of the sustain period TS) by sustain discharge pulses Ps between the X electrode Xi and the Y electrode Yi is different in sub-frames sf. This can determine a gradation value. The sustain discharge pulse Ps is a pulse at 0 V and a voltage Vs

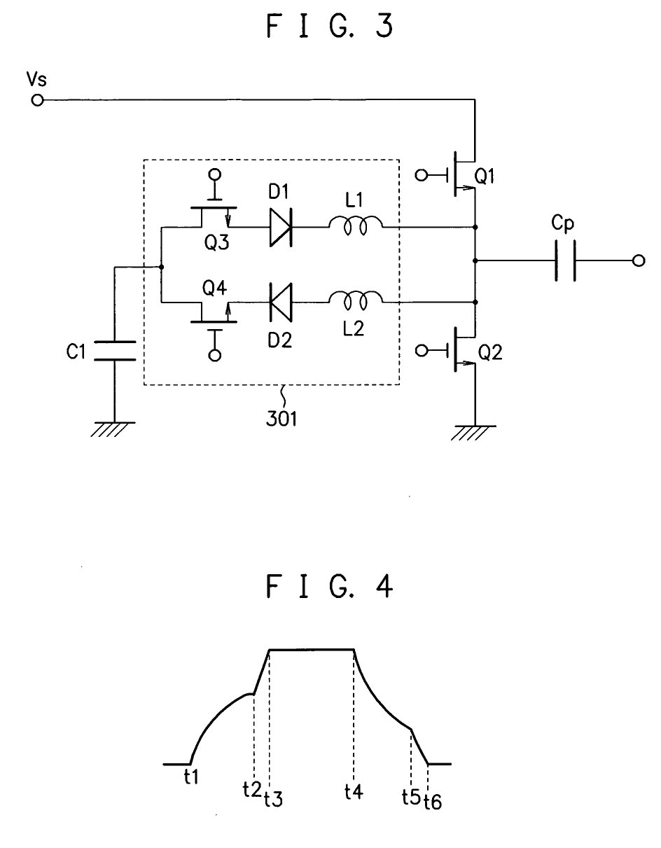

FIG. 3 is a circuit diagram showing a configuration example of each sustain circuit in the X-electrode drive circuit 4 and the Y-electrode drive circuit 5. The sustain circuit is a circuit for generating the sustain discharge pulse Pa in FIG. 5. A panel capacitance Cp is a capacitance between the X electrode Xi and the Y electrode Yi. As an example, a configuration example of the sustain circuit in the X-electrode drive circuit 4 will be described. The sustain circuit in the Y-electrode drive circuit 5 has the same configuration. Hereinafter, a MOS field effect transistor is referred only to as a transistor.

An N-channel transistor Q1 has a drain connected to the voltage Vs and a source connected to the X electrode Xi of the panel capacitance Cp. An N-channel transistor Q2 has a drain connected to the X electrode Xi of the panel capacitance Cp and a source connected to the ground. A coil L1 is connected between the X electrode Xi and the cathode of a diode D1. An N-channel transistor Q3 has a source connected to the anode of the diode D1. A coil L2 is connected between the X electrode Xi and the anode of a diode D2. An N-channel transistor Q4 has a source connected to the cathode of the diode D2. A capacitance C1 is connected between the interconnection point of the transistors Q3 and Q4 and the ground. This sustain circuit has a power recovery circuit 301. The power recovery circuit 301 includes the coils L1 and L2, the diodes D1 and D2, and the transistors Q3 and Q4.

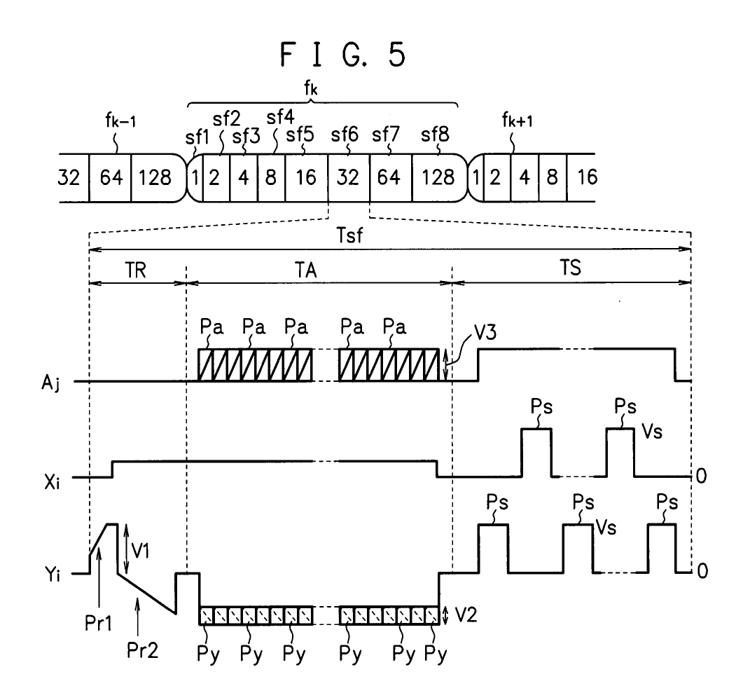

FIG. 4 is a diagram showing an example of the sustain discharge pulse Ps to the X electrode Xi generated by the sustain circuit in FIG. 3. At time t1, the transistor Q3 is turned on. Then, the charges charged in the capacitance C1 are supplied to the panel capacitance Cp by LC resonance. The voltage at the X electrode Xi rises from the ground. In other words, the recovered power is discharged. Subsequently, at time t2, the transistor Q3 is turned off, and the transistor Q1 is turned on. Then, the X electrode Xi is clamped at the voltage Vs. After time t3, the Xi electrode Xi is maintained at the voltage Vs. Subsequently, at time t4, the transistor Q1 is turned off, and the transistor Q4 is turned on. Then, the charges charged in the panel capacitance Cp are supplied to the capacitance C1 by LC resonance. The voltage at the X electrode Xi drops from the voltage Vs. In other words, the capacitance C1 recovers the power from the panel capacitance Cp. Subsequently, at time t5, the transistor Q4 is turned off, and the transistor Q2 is tuned on. Then, the X electrode Xi is clamped at the ground. After time t6, the X electrode Xi is maintained at the ground. Thereafter, the operations from t1 to t6 are repeated.

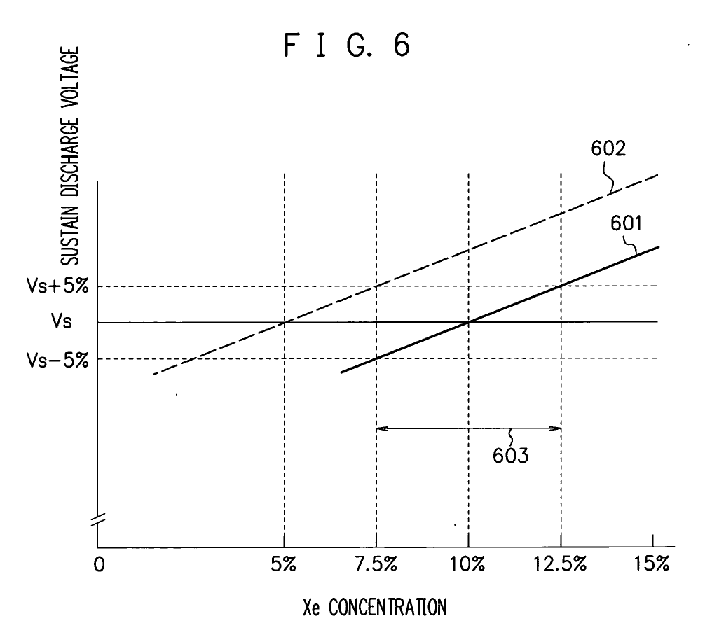

FIG. 6 is a graph showing the relationship between the Xe concentration in the discharge gas and the sustain discharge voltage. The horizontal axis shows the Xe concentration in the discharge gas. The vertical axis shows the sustain discharge voltage. During the sustain discharge period TS, the sustain discharge voltage Vs is applied between the X electrode Xi and the Y electrode Yi to cause discharge. The voltage Vs is, for example, 180 V.

A characteristic 601 is the characteristic of this embodiment. The dielectric layer 13 in FIG. 2 is a silicon oxide film formed by the plasma CVD method. The balance of the discharge gas other than Xe is composed of Ne.

A characteristic 602 is a characteristic of a comparative example. The dielectric layer 13 is made by baking a lead glass (containing PbO 70% and the balance SiO₂) at a high temperature. Other than Xe, the discharge gas is composed of 30% He and the balance Ne.

With a higher Xe concentration in the discharge gas, the light-emitting efficiency of the plasma display device is higher. When the sustain discharge voltage is Vs, the Xe concentration is 10% in the characteristic 601 in this embodiment, whereas the Xe concentration is 5% in the characteristic 602 of the comparative example. For the same sustain discharge voltage, the characteristic 601 in this embodiment is higher in the Xe concentration and increases in the light-emitting efficiency relative to the characteristic 602 of the comparative example. Especially in the case of the HDTV, the number of pixels is large, such as 1920×1080 pixels, leading to a decreased light-emitting area per pixel. Accordingly, it is useful that the light-emitting efficiency increases to present effect of increasing the brightness.

The plasma display device of this embodiment can ensure the operation at the sustain discharge voltage of Vs−5% to Vs+5%. The Xe concentration is 7.5% at the sustain voltage of Vs−5%, and the Xe concentration is 12.5% at the sustain voltage of Vs+5%. This embodiment can use a high concentration range 603 where the Xe concentration is 7.5% to 12.5%.

In the plasma display device conforming to the full-specification HDTV, the aperture ratio per pixel is small because of a large number of pixels, resulting in decreased brightness. In the characteristic 602 of the comparative example, when a lead glass (a relative dielectric constant of 13 to 14) is used for the dielectric layer 13, Xe is filled by 5%, and the sustain discharge voltage is Vs (180 V), the totally white brightness is 115 cd/m² (300 W) and the reactive power at the totally black time even exceeds 200 W.

It is desirable that the totally white brightness is 150 cd/m² (300 W) or more and the reactive power at the totally black time is 150 W or less. However, in the characteristic 602 of the comparative example, when the Xe concentration is increased to be higher than 5% so as to increase the brightness, the sustain discharge voltage needs to be higher than Vs (180 V), in which case the reactive power further increases. Increasing the sustain discharge voltage presents a problem of increasing the withstand voltage of a circuit element.

In contrast, in the characteristic 601 of this embodiment, the silicon oxide film having a low relative dielectric constant, such as about 4, is used for the dielectric layer 13, whereby the Xe concentration can be increased up to 10% while the sustain discharge voltage is maintained at Vs (180 V) to suppress the reactive power at the totally black time to 150 W or less. Further, since the Xe concentration is increased, the light-emitting efficiency increases so that the totally white brightness exceeds 150 cd/m². According to this embodiment, it is possible to conform to the full-specification HDTV with high definition and to realize both improvement in brightness and reduction in reactive power.

By bringing the Xe concentration to 5% in the characteristic 602 and the Xe concentration to 10% in the characteristic 601, it is possible to use the same sustain discharge voltage Vs and thus use the same circuits 4 to 8 in FIG. 1 and the same voltage waveform in FIG. 5 in both examples.

In this embodiment, it is preferable that the Xe concentration in the discharge gas existing between the front glass substrate 1 and the rear glass substrate 2 is within 10%±2.5%. Further, it is preferable that the sustain discharge voltage applied between the X electrode Xi and the Y electrode Yi is within 180 V±5% thereof. Furthermore, it is preferable that the plasma display device in this embodiment is capable of display of 1920 ×1080 pixels.

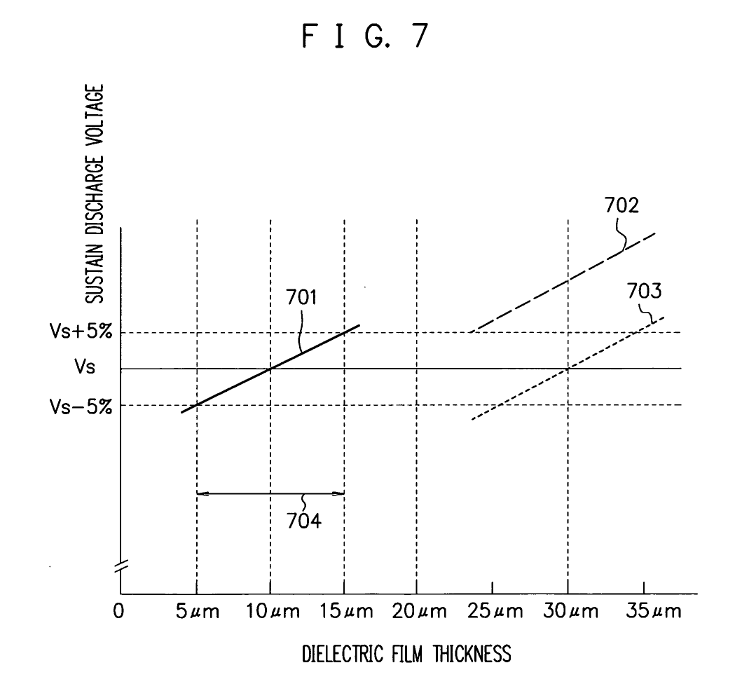

FIG. 7 is a graph showing the relationship between the thickness of the dielectric layer 13 and the sustain discharge voltage. The horizontal axis shows the thickness of the dielectric layer 13. The vertical axis shows the sustain discharge voltage. A characteristic 701 shows the characteristic of the characteristic 601 of this embodiment in FIG. 6 when the Xe concentration is 10%. A characteristic 702 shows the characteristic of the characteristic 602 of the comparative example in FIG. 6 when the Xe concentration is 10%. A characteristic 703 shows the characteristic of the characteristic 602 of the comparative example in FIG. 6 when the Xe concentration is 5%. As described with respect to FIG. 6, in the characteristics 701 and 703, the sustain discharge voltages can be brought to the same voltage Vs. The voltage Vs is, for example, 180 V. At that time, the thickness of the dielectric layer 13 is small, such as 10 μm in the characteristic 701, whereas the thickness of the dielectric layer 13 is large, such as 30 μm in the characteristic 703. In the characteristic 701, when the sustain discharge voltage is at Vs−5% and at Vs+5%, the thickness of the dielectric layer 13 is 5 μm and 15 μm respectively, which fall within a range 704. In the characteristic 702, the sustain discharge voltage is higher as compared to the characteristic 703, provided that the dielectric layer 13 has the same thickness. It is preferable that the dielectric layer 13 of this embodiment has a thickness within 10 μm±2.5 μm. Further, it is preferable that the sustain discharge voltage applied between the X electrode Xi and the Y electrode Yi is within 180 V±5% thereof.

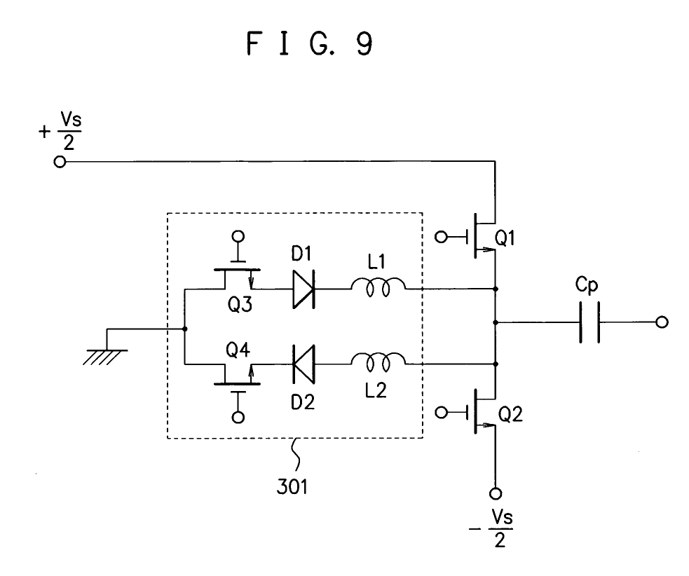

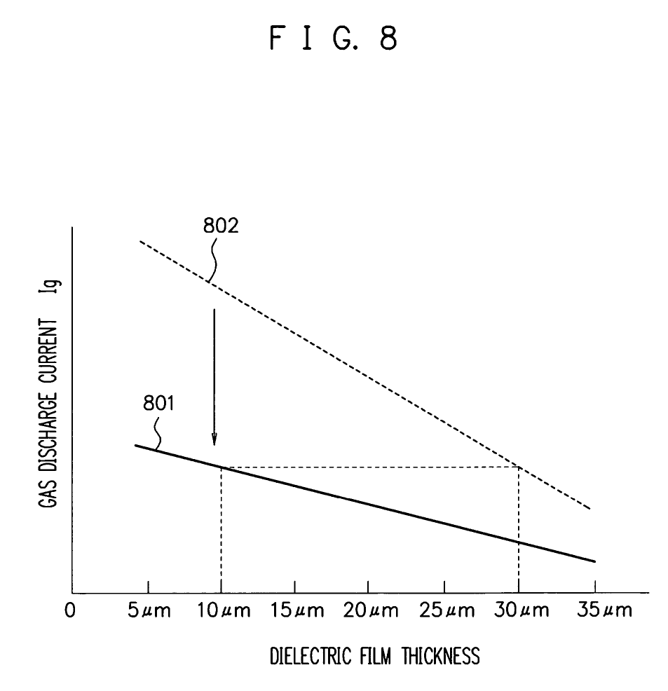

FIG. 8 is a graph showing the relationship between the thickness of the dielectric layer 13 and a gas discharge current Ig. The horizontal axis shows the thickness of the dielectric layer 13. The vertical axis shows the gas discharge current Ig at the time of the sustain discharge during the sustain discharge period TS. A characteristic 801 corresponds to the characteristic 601 of this embodiment in FIG. 6, in which the dielectric constant of the dielectric layer 13 is low. A characteristic 802 corresponds to the characteristic 602 of the comparative example in FIG. 6, in which the dielectric constant is high. In the characteristic 801 of this embodiment, the gas discharge current Ig is small as compared to the characteristic 802 of the comparative example when the dielectric layer 13 has the same thickness. Therefore, the power consumption can be reduced to suppress the heating value in this embodiment. As shown in FIG. 7, by setting the thickness of the dielectric layer 13 to 10 μm in the characteristic 701 and the thickness of the dielectric layer 13 to 30 μm in the characteristic 703, the same sustain discharge voltage Vs could be used. Similarly, by setting the thickness of the dielectric layer 13 to 10 μm in the characteristic 801 and the thickness of the dielectric layer 13 to 30 μm in the characteristic 802, the same gas discharge current Ig can be used. In other words, it is possible to use the same circuits 4 to 8 in FIG. 1 and the same voltage waveform in FIG. 5 in both examples.

As described above, according to this embodiment, by using the dielectric layer 13 made of the silicon oxide film, the Xe concentration in the discharge gas can be increased. This can improve the light-emitting efficiency to realize high brightness. Further, the reactive power can be suppressed.

(Second Embodiment)

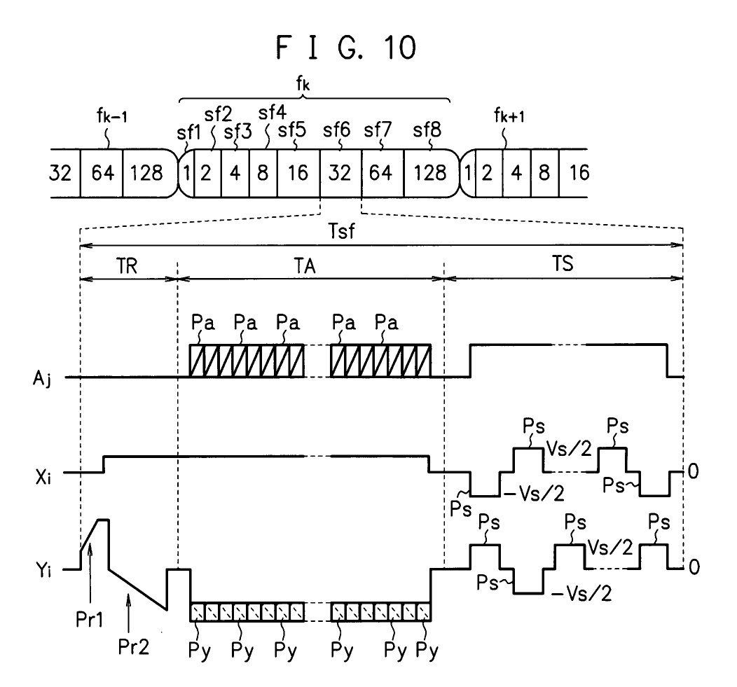

FIG. 10 is a diagram showing a configuration example of one frame fk of an image according to a second embodiment of the present invention. FIG. 10 is different from FIG. 5 only in the sustain discharge pulse Ps during the sustain discharge period TS and the same in other points. Hereafter, the point of the second embodiment different from the first embodiment will be described. For the sustain discharge pulse Ps to the X electrode Xi and the Y electrode Yi is formed such that a pulse at Vs/2 and a pulse at −Vs/2 are alternately formed. More specifically, a maximum value of Vs/2 and a minimum value of −Vs/2 of the sustain discharge pulse Ps supplied to the X electrode Xi and the Y electrode Yi are the same in absolute value and reversed in polarity. In this embodiment, the potential difference Vs is applied between the X electrode Xi and the Y electrode Yi to cause a sustain discharge.

FIG. 9 is a circuit diagram showing a configuration example of a sustain circuit for generating the sustain discharge pulse Ps in FIG. 10. This sustain circuit is a TERES (Technology of Reciprocal Sustainer) circuit. Points of FIG. 9 different from those in FIG. 3 will be described. The drain of a transistor Q1 is connected to a voltage of +Vs/2. The source of a transistor Q2 is connected to a voltage of −Vs/2. The interconnection point of transistors Q3 and Q4 is connected to the ground. The operation of the sustain circuit is the same as that of the circuit in FIG. 3, in which the switching elements Q1 to Q4 supply alternately two predetermined voltages different in polarity (Vs/2 and −Vs/2) to the X electrode Xi and the Y electrode Yi. The sustain circuit also has a power recovery circuit 301 as in the circuit in FIG. 3. In the sustain circuit in this embodiment, each circuit element only requires a withstand voltage of Vs/2, that is low voltage, rather than Vs, and therefore can reduce the cost.

(Third Embodiment)

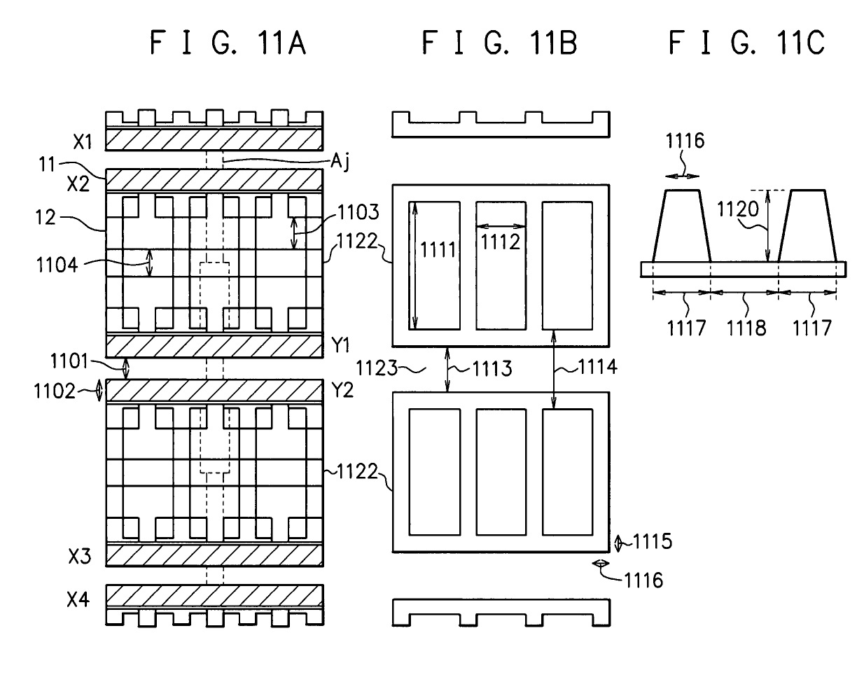

FIG. 11B is a plan view showing a configuration example of ribs 1122 according to a third embodiment of the present invention, Fig. 11C is a sectional view thereof, and FIG. 11A is a plan view of the ribs 1122, the X electrodes Xi, the Y electrodes Yi, and the address electrodes Aj. In the first embodiment in FIG. 2, the rib 9 is a stripe-type rib disposed parallel to the address electrodes 15. This embodiment has ladder-type ribs 1122. The ladder-type ribs 1122 are partitioned in units of the display cell Cij composed of the X electrode Xi, the Y electrode Yi, and the address electrode Aj, and include an exhaust path 1123. Hereinafter, points of this embodiment different from the first embodiment will be described.

In FIG. 11B, the rib 1122 has, for example, a vertical opening 1111 of 390 μm and a horizontal opening 1112 of 160 μm. The exhaust path 1123 has a width 1113 of, for example, 140 μm. The total width 1114 in the vertical direction of the ribs 1122 across the exhaust path 1123 is, for example, 240 μm. The rib 1122 has a vertical top width 1115 and a horizontal top width 1116 which are both, for example, 50 μm.

In FIG. 11C, a rib height 1120 is, for example, 120 μm. A rib bottom width 1117 is, for example, 100 μm. An inter-rib distance 1118 is, for example, 110 μm. The pitch between the display cells Cij is, for example, 0.63 mm×0.21 mm.

In FIG. 11A, the X electrode Xi and the Y electrode Yi have transparent electrodes 12 and bus electrodes 11 as in FIG. 2. The transparent electrodes 12 are ladder-type transparent electrodes. A head vertical width 1103 of the transparent electrode 12 is, for example, 95 μm. A distance 1101 between the Y electrodes Y1 and Y2 is, for example, 80 μm. A width 1102 of the bus electrode 11 is, for example, 60 μm. A slit (discharge gap) 1104 between the head of the transparent electrode 12 of the X electrode X2 and the head of the transparent electrode 12 of the Y electrode Y1 adjacent thereto is, for example, 80 μm.

The exhaust path 1123 will be described. The space between the front glass substrate 1 and the rear glass substrate 2 in FIG. 2 is evacuated via the exhaust path 1123. Then, a discharge gas is filled in the space between the front glass substrate 1 and the rear glass substrate 2 via the exhaust path 1123.

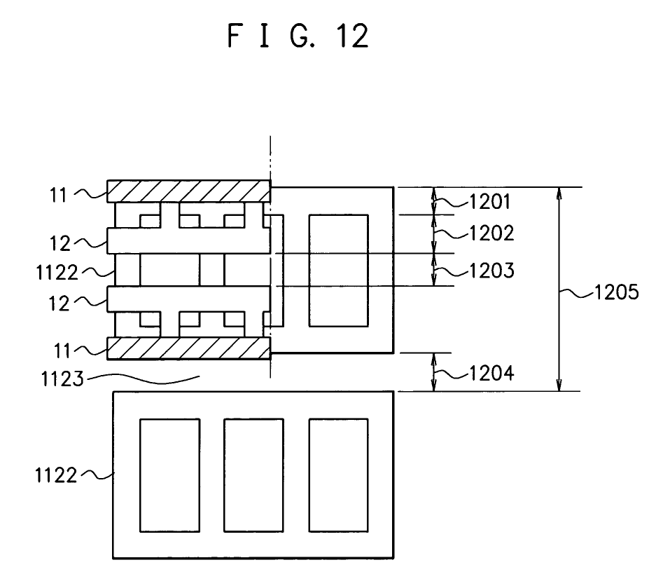

FIG. 12 is a plan view showing, similarly to FIG. 11A, a configuration example of the bus electrodes 11, the transparent electrodes 12, and the ribs 1122. Numeral 1201 denotes a top width of the rib 1122. Numeral 1202 denotes a spacing (edge clearance) between the edge of a discharge gap 1203 and the edge of the rib 1122. Numeral 1203 denotes a discharge gap between the X electrode Xi and the Y electrode Yi. Numeral 1204 denotes a width of the exhaust path 1123. Numeral 1205 denotes the pitch of the display cell.

At the machining accuracy of the rib at present, it is necessary that the exhaust path width 1204 is 100 μm or more and the top width 1201 of the rib is 50 μm or more. Further, since the line-to-line capacitance is large if the discharge gap 1203 is too narrow, the discharge gap 1203 is desirably 80 μm or more. Furthermore, in consideration of the alignment accuracy between the front glass substrate 1 and the rear glass substrate 2 in FIG. 2, the spacing (edge clearance) 1202 between the edge of the discharge gap 1203 and the edge of the rib 1122 needs to be 50 μm or more. This results in that the display cell pitch 1205 is desirably at least 380 μm or more.

The plasma display device in this embodiment can be conformed to the full-specification HDTV having 1920×1080 pixels. In this case, the number of lines extending in a direction parallel to the exhaust path 1123 needs to be 1080 or more, and the line pitch 1205 is preferably 380 μm or more. The dielectric layer 13 in FIG. 2 preferably has a thickness of 32 μm or less, more preferably 10 μm or less.

The Xe concentration in the discharge gas can be increased by using the dielectric layer made of a silicon oxide film. This can improve the light-emitting efficiency to realize high brightness.

The present embodiments are to be considered in all respects as illustrative and no restrictive, and all changes which come within the meaning and range of equivalency of the claims are therefore intended to be embraced therein. The invention may be embodied in other specific forms without departing from the spirit or essential characteristics thereof.

What is claimed is:

1. A plasma display device, comprising:
a first substrate and a second substrate;
a first electrode and a second electrode formed on said first substrate to perform sustain discharge on said first substrate;
a third electrode formed on said second substrate to perform address discharge between said second electrode and said third electrode;
a dielectric layer formed of a silicon oxide film in a manner to cover said first and second electrodes on said first substrate; and
a discharge gas existing between said first and second substrates and having a Xe concentration within 10%±2.5%,
wherein said dielectric layer has a thickness within 10 μm±2.5 μm, and wherein said first to third electrodes constitute one pixel, and display of 1920×1080 pixels is possible.

2. The plasma display device according to claim 1,
wherein a sustain discharge voltage applied between said first and second electrodes is within 180 V±5% thereof.

3. The plasma display device according to claim 1, further comprising:
a ladder-type rib partitioned in unit of a display cell constituted of said first to third electrodes and including an exhaust path,
wherein the number of lines extending in a direction parallel to said exhaust path is 1080 or more, and
wherein the line pitch is 380 μm or more.

4. The plasma display device according to claim 1,
wherein said dielectric layer is formed by a plasma CVD method.

5. The plasma display device according to claim 1, further comprising:
a switching element supplying two voltages different in polarity alternately to said first and second electrodes.

6. The plasma display device according to claim 1, further comprising:
a power recovery circuit supplying a voltage to said first and second electrodes via a coil.

7. The plasma display device according to claim 1,
wherein a maximum value and a minimum value of a sustain discharge pulse supplied to said first and second electrodes are the same in absolute value and reversed in polarity.

8. The plasma display device according to claim 1,
wherein said first to third electrodes constitute a display cell,
wherein an amplitude absolute value of a reset pulse applied to said second electrode to reset said display cell is 180 V to 200 V,
wherein an amplitude absolute value of an address pulse applied to said third electrode to cause address discharge between said second and third electrodes is 60 V to 70 V, and
wherein an amplitude absolute value of a scan pulse applied to said second electrode in correspondence with the address pulse is 110 V to 130 V.

9. The plasma display device according to claim 5,
wherein said dielectric layer has a thickness of 32 μm or less.

10. The plasma display device according to claim 5,
wherein said dielectric layer has a thickness of 10 μm or less.

11. A plasma display device, comprising:
a first substrate and a second substrate;
a first electrode and a second electrode formed on said first substrate to perform sustain discharge on said first substrate;
a third electrode formed on said second substrate to perform address discharge between said second electrode and said third electrode; and
a dielectric layer formed of a silicon oxide film in a manner to cover said first and second electrodes on said first substrate, and having a thickness within 10 μm±2.5 μm.

12. The plasma display device according to claim 11,
wherein a sustain discharge voltage applied between said first and second electrodes is within 180 V±5% thereof.

13. The plasma display device according to claim 11,
wherein said first to third electrodes constitute one pixel, and display of 1920×1080 pixels is possible.

14. The plasma display device according to claim 11, further comprising:
a ladder-type rib partitioned in unit of a display cell constituted of said first to third electrodes and including an exhaust path,
wherein the number of lines extending in a direction parallel to said exhaust path is 1080 or more, and
wherein the line pitch is 380 μm or more.

15. The plasma display device according to claim 11,
wherein said dielectric layer is formed by a plasma CVD method.

16. The plasma display device according to claim 11,
wherein a maximum value and a minimum value of a sustain discharge pulse supplied to said first and second electrodes are the same in absolute value and reversed in polarity.

17. The plasma display device according to claim 11,
wherein said first to third electrodes constitute a display cells,
wherein an amplitude absolute value of a reset pulse applied to said second electrode to reset said display cell is 180 V to 200 V,
wherein an amplitude absolute value of an address pulse applied to said third electrode to cause address discharge between said second and third electrodes is 60 V to 70 V, and
wherein an amplitude absolute value of a scan pulse applied to said second electrode in correspondence with the address pulse is 110 V to 130 V.

18. The plasma display device according to claim 14,
wherein said dielectric layer has a thickness of 32 μm or less.

19. The plasma display device according to claim 14,
wherein said dielectric layer has a thickness of 10 μm or less.

20. The plasma display device according to claim 12,
wherein said first to third electrodes constitute pixel, and display of 1920×1080 pixels is posssible.
